(19) United States
(12) Patent Application Publication
(10) Pub. No.: US 2012/0328786 A1
(43) Pub. Date: Dec. 27, 2012

(54) METAL SURFACE TREATMENT SOLUTION AND METHOD OF MANUFACTURING STEEL SHEET USING THE SAME

(75) Inventors: JONG GI KIM, Chungcheongnam-Do (KR); Sang Jin Park, Gyeonggi-Do (KR); Man Been Moon, Gyeonggi-Do (KR); Hyun Woon Oh, Seoul (KR)

(73) Assignee: Hyundai Hysco, Ulsan (KR)

(21) Appl. No.: 13/556,586

(22) Filed: Jul. 24, 2012

Related U.S. Application Data
(62) Division of application No. 12/624,208, filed on Nov. 23, 2009.

(30) Foreign Application Priority Data
May 23, 2008 (KR) 10-2008-0048013

(51) Int. Cl. B05D 3/02; B05D 1/18; B05D 1/28

(52) U.S. Cl. 427/386; 427/428.01; 427/428.05; 427/435

(57) ABSTRACT

Disclosed herein is a metal surface treatment solution that can provide superior corrosion resistance and paint adhesion. The metal surface treatment solution includes 9˜13 wt % of an epoxy-based silane coupling agent, 5˜9 wt % of an amino-based silane coupling agent, 0.5˜1 wt % of a vanadium compound, 0.5˜1 wt % phosphoric acid; 0.5˜1 wt % of an organic acid, 0.1˜10 wt % of a Ti-Alkoxide, 0.1˜2 wt % of a chelating agent, 0.1˜5 wt % of a calcium phosphate-based compound,. 0.2˜10 wt % of a colloidal silica, and the balance of solvents. A method of manufacturing a surface treated steel sheet using the same is also disclosed.

### TECHNICAL FIELD

The present invention relates to a metal surface treatment solution and a method of manufacturing a surface treated steel sheet using the same. More particularly, the present invention relates to a technique for low temperature hardening and capable of easily ensuring corrosion resistance of a metal sheet.

### BACKGROUND ART

Surface treated steel sheets have been increasingly demanded for construction materials, electronic appliances, and vehicles in many countries.

Particularly, domestic or foreign cold-rolled steel sheet manufacturers and other small and medium steel-based surface treatment enterprises perform, as final post-treatment, chemical treatment such as chromate treatment and phosphate treatment when manufacturing hot-dip galvanized steel sheets and electronic galvanized steel sheets. The chromate treatment refers to covering a steel sheet with an antirust coating by immersing the steel sheet in a solution mainly composed of chromic acid or dichromate, The chromate treatment imparts good corrosion resistance and paint adhesion to the steel sheet at low processing costs.

However, since chromium is one of representative toxic pollutants and causes severe damage to workers and the environment, regulations for restricting the use of such toxic pollutants have been enacted in developed countries and implementation of the regulations have also proceeded worldwide. Additionally, for chromate treated steel sheets, the chromate treatment inevitably generates hexavalent chromium (Cr⁺⁶) in wastewater, which necessitates highly expensive and time-consuming wastewater treatment. Moreover, since it is expected that the use of chromate treatment will be prohibited in the near future through international regulations on the use of chromium, studies relating to the chromate have not proceeded further and development of materials capable of replacing chromium have been actively studied worldwide.

From the early studies, it has been attempted so far to develop a 100% trivalent chromium solution by reducing the amount of hexavalent chromium since the hexavalent chromium is more toxic than the trivalent chromium. However, these studies do not aim at removal of chromium and the 100% trivalent chromium solution does not have any merit to replace the existing chromate solution in view of corrosion resistance and price.

On the other hand, in recent papers, it is attempted to perform chemical treatment of the steel sheet using an organic material such as alkoxysilane instead of inorganic materials such as chromate and phosphate.

Alkoxysilane is represented by chemical formula Y—Si(OR), where Y indicates organofunctional groups, such as vinyl, amino, epoxy, and mercapto groups, and serves to enhance an adhesive force. Further, OR indicates an alkoxy group such as —OCH₃ and —OC₂H₅, and water soluble SiOH is chemically coupled thereto in a metal base layer. Alkoxysilane demonstrates excellent effects in enhancement of corrosion resistance and adhesion of a coating, but its industrial use is limited since the alkoxysilane is several dozen times more expensive than the chromate. Moreover, the chemical treatment using the alkoxysilane cannot be realized in practice in the near future due to low productivity of alkoxysilane. Additionally, although many materials have been studied as a candidate for replacement of chromium, results of the studies are very restrictively provided.

As described above, it has been actively attempted to develop a candidate material for replacing chromium that is inexpensive and demonstrates good corrosion resistance with only a small coating amount (50 mg/m² or less). However, development of a galvanized steel sheet, to which a material exhibiting similar corrosion resistance to chromium with a small coating amount is applied, has not yet succeeded.

### DISCLOSURE

### Technical Problem

It is an aspect of the present invention to provide a metal surface treatment solution and a method of manufacturing a surface treated steel sheet using the same. Here, the treatment solution is prepared by preparing a solution which comprises an epoxy-based silane coupling agent, an amino-based silane coupling agent, a vanadium compound, phosphoric acid and an organic acid to impart antirust properties to a metal surface, followed by adding, to this solution, a Ti-Alkoxide for corrosion resistance, low temperature hardening and crosslinking reaction, a chelating agent for solution stabilization, a calcium phosphate-based compound for corrosion resistance, and a colloidal silica for bearing properties, corrosion resistance and black sulfide stain resistance, thereby ensuring excellent bearing properties, corrosion resistance, and black sulfide stain resistance.

### Technical Solution

In accordance with an aspect of the invention, a metal surface treatment solution includes: 9˜13% by weight (wt %) of an epoxy-based silane coupling agent; 5˜9 wt % of an amino-based silane coupling agent; 0.5˜1 wt % of a vanadium compound; 0.5˜1 wt % phosphoric acid; 0.5˜1 wt % of an organic acid; 0.1˜10 wt % of a Ti-Alkoxide; 0.1˜2 wt % of a chelating agent; 0.1˜5 wt % of a calcium phosphate-based compound; 0.2˜10 wt % of a colloidal silica; and the balance of solvents.

Here, an equivalence ratio of the epoxy-based silane coupling agent to the amino-based silane coupling agent may be 3:1˜1:3. The epoxy-based silane coupling agent and the amino-based silane coupling agent may be added in an amount of 30˜70 wt % with respect to a total amount of solids. The Ti-Alkoxide may include at least one selected from butoxy, ethoxy, propoxy and titanate. The chelating agent may be an N-containing type and may include at least one selected from dimethyl-glyoxime, EDTA, polyaminocarboxylic acids, polyphosphoric acid, ethylenethiourea, and iminourea. The calcium phosphate-based compound may include zinc salt and at least one selected from calcium phosphate, calcium hydrogen phosphate, calcium phosphate tribasic, and calcium phosphate monobasic.

In accordance with another aspect of the invention, a method of manufacturing a surface treated steel sheet includes applying the metal surface treatment solution to a surface of a steel sheet by one process selected from a roll coater process, a process of squeezing the solution from a roll after spraying the solution, and a process of dipping the material in the solution.

### Advantageous Effects

According to embodiments of the invention, the metal surface treatment solution is prepared by further comprising the Ti-Alkoxide, the chelating agent, the calcium phosphate-based compound and the colloidal silica, and a surface treated steel sheet is manufactured through surface treatment using the metal surface treatment solution instead of the existing chromate treatment, so that the metal surface treatment solution provides the surface treated steel sheet with improved or the same corrosion resistance and black sulfide stain resistance as those of the conventional treatment while enabling low temperature hardening to thereby improve the quality of the surface treated steel sheet.

### BEST MODE

A metal surface treatment solution and a method of manufacturing a surface treated steel sheet using the same according to the invention will now be described in detail with reference to embodiments.

In the description of the following embodiments, a general hot-dip galvanized steel sheet is used as a material for surface treatment, but it should be understood that the invention is not limited thereto.

First, a zinc-coated layer is formed on a steel sheet and a surface treatment solution is then applied to the zinc-coated layer.

Here, the surface treatment solution is prepared as follows.

First, a first solution is prepared by adding 9˜43% wt % of an epoxy-based silane coupling agent and 5˜9 wt % of an amino-based silane coupling agent to a mixture of 60˜80 wt % pure water and 5˜15 wt % ethanol, followed by hydrolysis of the resultant.

Here, an equivalence ratio of the epoxy-based silane coupling agent to the amino-based silane coupling agent may be adjusted in the range of 3:1˜1:3, and the added amount of the epoxy-based silane coupling agent and the amino-based silane coupling agent may be adjusted in the range 30˜70 wt % with respect to a total amount of solids.

Here, the solids refer to all raw materials excluding water and ethanol. A composition described below also contains a predetermined amount of non-volatile powder, and will be contemplated in calculating the weight ratio of the solids.

Further, ethanol is used as a co-solvent to dissolve a water-insoluble silane (particularly, an amino-based silane coupling agent). Since ethanol can provide an additive effect such as foam resistance, it is desirable to adjust the added amount of ethanol. Ethanol may be added in an amount of 40˜80% by weight with respect to a total weight of the silane coupling agents. If less than 40% ethanol is added, the solubility of the silane coupling agents is reduced to deteriorate solution stability. If more than 80% ethanol is added, the ethanol scent is strong and volatilization is promoted, thereby deteriorating the solution stability.

Next, main properties and kind of compositions will be described. First, the epoxy-based silane coupling agent is a fundamental compound which imparts bearing properties and corrosion resistance to the steel sheet. In one embodiment, the epoxy-based silane coupling agent comprises at least one selected from vinyl methoxy silane, vinyl trimethoxy silane, vinyl epoxy silane, vinyl triepoxy silane, 3-aminopropyltriethoxy silane, 3-glycidoxypropyltrimethoxy silane, 3-metaglyoxypropyltrimethoxy silane, and gamma-glycidoxypropyltriethoxy silane.

The amino-based silane coupling agent also imparts bearing properties and corrosion resistance to the steel sheet. In one embodiment, the amino-based silane coupling agent comprises at least one selected from N-(beta-aminoethyl)-gamma-aminopropylmethyldiraethoxy silane, N-(beta-aminoethyl)-gamma-aminopropylmethyldimethoxy silane, gamma-aminopropylfiidimethoxy silane, and gamma-aminopropyltridiethoxy

In this invention, it is very important to adjust the equivalence ratio between the epoxy-based and amino-based silane coupling agents as well as the weight ratio thereof.

If the equivalence ratio of the epoxy-based silane coupling agent to the amino-based silane coupling agent exceeds 3:1, the corrosion resistance and coating adhesion can be deteriorated, and if the equivalence ratio is less than 1:3 or less, the solution stability and coating properties can be deteriorated. Further, if the content of solids is less than 30% in the silane coupling agent, improvement in corrosion resistance, adhesion, and paintability can become insignificant, and if the content of solids exceeds 70%, the solution stability can be rapidly deteriorated, thereby significantly reducing the effect of improving the corrosion resistance.

Such characteristics can be seen from variation in corrosion resistance, adhesion, solution stability, low temperature hardening, and paintability depending on the equivalence ratio of the epoxy-based silane coupling agent to the amino-based silane coupling agent, as shown in Table 1.

TABLE 1

| | | | | | Low- | |
|---|---|---|---|---|---|---|
| | Equiv- | | | | temp. | |
| | alence | Corrosion | Adhe- | Solution | hard- | Paint- |
| | ratio | resistance | sion | Stability | ening | ability |
| Comparative | 1:0 | x | Δ-x | ∘ | Δ | Δ-x |
| Example 1 | | | | | | |
| Comparative | 4:1 | Δ | Δ | ∘ | ∘ | Δ |
| Example 2 | | | | | | |
| Example 1 | 3:1 | ∘ | ∘ | ∘ | ∘ | ∘ |
| Example 2 | 2:1 | ∘ | ∘ | ∘ | ∘ | ∘ |
| Example 3 | 1:1 | ∘ | ∘ | ∘ | ∘ | ∘ |
| Example 4 | 1:2 | ∘ | ∘ | ∘ | ∘ | ∘ |
| Example 5 | 1:3 | ∘ | ∘ | ∘ | Δ-∘ | ∘ |
| Comparative | 1:4 | ∘ | ∘ | Δ | Δ | ∘ |
| Example 3 | | | | | | |
| Comparative | 0:1 | Δ | ∘ | x | x | ∘ |
| Example 4 | | | | | | |

∘: excellent, Δ: good, x: bad

As can be seen from Table 1, only for Examples 1 to 5 which have an equivalence ratio of the epoxy-based silane coupling agent to the amino-based silane coupling agent in the range of 1:3˜3:1, the corrosion resistance, adhesion, solution stability, low temperature hardening, and paintability are excellent. Thus, it is important to prepare the first solution by adding the epoxy-based silane coupling agent and the amino-based silane coupling agent.

Next, after hydrolysis is finished as described above and the first solution containing the silane compounds is prepared, 0.5˜1 wt % of a vanadium compound, 0.5˜1 wt % phosphoric acid, and 0.5˜1 wt % of an organic acid are dissolved in the first solution, followed by stirring for 30˜60 minutes to prepare a second solution.

The vanadium compound is used as a composition which provides corrosion resistance to the surface of metal, and may comprise at least one selected from vanadium pentoxide, vanadium trioxide, ammonium metavanadate, vanadium oxyacetylacetonate, vanadium acetylacetonate, and vanadium trichloride. If the added amount of vanadium compound is less than 0.5 wt %, the corrosion resistance and alkali resistance can be deteriorated, and if the added amount exceeds 1 wt %, solubility is lowered, thereby deteriorating storage stability.

The phosphoric acid (H₃PO₄) serves to adjust adhesion and pH of the surface treatment solution, and the organic acid serves to stabilize the solution. The organic acid may comprise at least one selected from carboxylic acid, succinic acid, citric acid, and ascorbic acid. If the added amounts of phosphoric acid and organic acid are less than 0.5 wt %, adhesion can be deteriorated, and if the added amounts thereof exceed 1 wt %, pH adjustment of the surface treatment solution becomes difficult, thereby deteriorating the solution stability.

On the other hand, the surface treatment solution according to the invention does not contain a magnesium compound and an antifoaming agent that are used in the conventional technique.

If the magnesium compound is added, magnesium divalent ions present in the solution react with a chelating agent, thereby promoting a crosslink reaction with binders. Addition of magnesium can provide improved corrosion resistance but deteriorates stability of the solution due to difficulty in control of the added amount thereof. Furthermore, since zinc elution occurs to promote the side-effect by addition of magnesium during the use of the magnesium-containing solution, the present invention avoids the use of divalent metals in consideration of the solution stability.

The antifoaming agent is used to remove bubbles, thereby preventing appearance damage and the like, which results from generation of bubbles. However, for ensuring such effects, it is necessary for the antifoaming agent to have incompatibility with oils or silicon-containing solutions. The use of such an antifoaming agent is liable to cause invisible surface damage in a thin film coating, which in turn will cause paint defects (adhesion defects).

Therefore, according to the invention, surfactant components such as a wetting agent, a dispersing agent, and the like are minimized to solve problems related to antifoaming properties. Thus, ethanol is used as a co-solvent in addition to water to suppress defects caused by bubbles by lowering viscosity of the solution and allowing easy removal of bubbles, thereby further enhancing paintability.

After preparing the second solution, 0.1˜10 wt % of a Ti-Alkoxide, 0.1˜2 wt % of a chelating agent, 0.1˜5 wt % of a calcium phosphate-based compound, and 0.2˜10 wt % of a colloidal silica are added to the second solution, followed by stirring at 1500 rpm for 30˜60 minutes at room temperature, thereby preparing a metal surface treatment solution. Here, the Ti-Alkoxide serves to enhance corrosion resistance, crosslinking reaction and low temperature hardening, and may comprise at least one selected from butoxy, ethoxy, propoxy, and titanate. Here, if the content of Ti-Alkoxide is less than 0.1 wt % in the solution, improvement in corrosion resistance, crosslinking reaction and low temperature hardening can become insignificant, and if the content of Ti-Alkoxide exceeds 10 wt %, the solution stability can be deteriorated.

The chelating agent is used as a composition for stabilizing the solution while enhancing the corrosion resistance, and may be an N-containing type. The chelating agent may comprise at least one selected from dimethyl-glyoxime, EDTA, polyaminocarboxylic acids, polyphosphoric acid, ethylenethiourea, and iminourea. If the content of chelating agent is less than 0.1 wt % in the solution, the corrosion resistance can be deteriorated, and if the content of chelating agent exceeds 2 wt %, the solution stability can be deteriorated.

The calcium phosphate-based compound is also used as a composition for improving the corrosion resistance. The calcium phosphate-based compound may comprise zinc salt and at least one selected from calcium phosphate, calcium hydrogen phosphate, calcium phosphate tribasic, and calcium phosphate monobasic. If the content of calcium phosphate-based compound is less than 0.1 wt % in the solution, the corrosion resistance can be deteriorated, and if the content of calcium phosphate-based compound exceeds 5 wt %, improvement in corrosion resistance can become insignificant and the solution stability can be deteriorated.

Further, the colloidal silica is used as a composition for imparting bearing properties, corrosion resistance, and black sulfide stain resistance. The colloidal silica is mainly composed of SiO₂. If the content of colloidal silica is less than 0.2 wt % in the solution, the bearing properties, corrosion resistance and black sulfide stain resistance can be deteriorated, and if the content of colloidal silica exceeds 10 wt %, the solution stability can be deteriorated.

Next, a method of manufacturing a steel sheet coated with a Cr-free metal surface treatment solution according to one embodiment of the invention will be described.

First, a general steel sheet such as a hot-dip galvanized steel sheet is prepared and subjected to pretreatment. The pretreatment is typically performed to remove grease and stains adhrered to the steel sheet and may include, but is not limited to, cleansing with an alkaline or acidic degreasing agent, hot water cleansing, and solvent cleansing. Then, the steel sheet may be subjected to surface conditioning with an acid, an alkali or the like. Preferably, as little as possible of the cleansing agent remains on the surface of the steel sheet or is removed by water washing after cleansing the surface of the steel sheet, Further, although a surface treatment solution according to one embodiment may be directly applied to the steel sheet after cleansing the steel sheet, it can be applied after phosphate-based chemical treatment.

Then, a surface treatment solution according to one embodiment is applied to the surface of the steel sheet. By way of non-limiting examples, a process of applying the solution includes a roll coater process in which a coating solution is transferred to the metal surface using a roll, a process of squeezing the solution from a roll after spraying the solution, and a process of dipping the steel sheet in the solution.

Then, the metal surface treatment solution on the steel sheet is dried for 0.1˜60 seconds. Here, drying may be performed to leave behind 0.05˜1.0 g/m² of a dried coating on the surface of the steel sheet. More preferably, drying is performed to leave behind 0.05˜0.8 g/m² of a dried coating on the surface of the steel sheet.

Additionally, a pH value of the metal surface treatment solution applied to the surface of the steel sheet may be adjusted in the range of 3.0˜7.0 using an organic/inorganic acid as described above. If the pH of the metal surface treatment solution exceeds 7.0, stability of the metal surface treatment solution is lowered to cause gelation or deposition of the metal surface treatment solution.

Next, the metal surface treatment solution coated on the surface of the steel sheet is heated. Heating may be performed at 30˜200 t.

If the metal surface treatment solution on the steel sheet is heated at temperatures less than 30° C., the corrosion resistance and black sulfide stain resistance can be deteriorated. In the case where the treatment solution is heated at high temperatures above 200° C., equipment investment for construction of a drying furnace or the like must proceed to such a high temperature drying process, and this is unreasonable in view of energy consumption. As such, since drying the metal surface treatment solution at high temperatures can cause deterioration of productivity, the heating temperature of the metal surface treatment solution on the steel sheet may be in the range of 30˜200° C.

Next, examples and, comparative examples prepared using various metal surface treatment solutions will be described along with evaluation results of physical properties thereof.

TABLE 2
Comparison of metal surface treatment solutions used for manufacturing
examples and comparative examples (% by weight)

| | A | B | C | D | E | F | G | H | I |
|---|---|---|---|---|---|---|---|---|---|
| Example 6 | 9 | 5 | 0.8 | 0.8 | 0.8 | 1.5 | 1 | 1 | 2 |
| Example 7 | 9 | 9 | 1 | 0.8 | 0.8 | 2 | 0.2 | 0.5 | 4 |
| Example 8 | 13 | 5 | 1 | 1 | 1 | 2 | 0.2 | 5 | 4 |
| Example 9 | 13 | 9 | 0.7 | 1 | 1 | 2 | 0.2 | 1 | 6 |
| Comparative | 9 | 5 | 0.7 | 0.8 | 0.8 | x | 0.2 | 0.5 | 12 |
| Example 5 | | | | | | | | | |
| Comparative | 9 | 9 | 0.7 | 0.8 | 0.8 | 2 | x | 8 | 4 |
| Example 6 | | | | | | | | | |
| Comparative | 13 | 5 | 0.7 | 1 | 1 | 12 | 0.2 | x | 6 |
| Example 7 | | | | | | | | | |
| Comparative | 13 | 9 | 1 | 2 | 1 | 2 | 3 | 0.5 | x |
| Example 8 | | | | | | | | | |

A: epoxy-based silane coupling agent, B: amino-based silane coupling agent, C: vanadium compound, D: phosphoric acid, E: organic acid, F: Ti-Alkoxide, G: chelating agent, H: calcium phosphate-based compound, I: colloidal silica

Physical properties of the metal surface treatment solutions used for the examples and comparative examples were tested under the following conditions.

1) Corrosion resistance

The corrosion resistance was measured by checking a white rust generation ratio with lapse of time on a steel sheet treated using a solution prepared in accordance with ASTM B 117. The results were evaluated by the following standard.

Excellent: 0% area of white rust generation after 24 hours

Good: less than 5% area of white rust generation after 24 hours

Bad: 5% or more area of white rust generation after 24 hours

2) Adhesion

After cross-hatching a coating on the steel sheet with 11 lines spaced a distance of 1 mm from each other in each of transverse and longitudinal directions in accordance with ASTM D3359 to form 100 blanks on the coating, a cellophane tape was used to test adhesion of the coating. The results were evaluated by the following standard.

Excellent: 100% residual ratio of coating

Good: 95% or more residual ratio of coating

Bad: 95% or less residual ratio of coating

3) Storage stability

After storing the prepared solution in a constant temperature device at 40° C. for 2 months, viscosity increase, gelation and deposition of compositions in the solution were observed and evaluated by the following standard.

O: Variation of compositions such as viscosity increase, gelation and deposition were not acknowledged.

X: Variation of compositions such as viscosity increase, gelation and deposition were acknowledged.

4) Cr reactivity

After mixing the prepared solution and a Cr solution in a ratio of 1:1 and leaving the mixture for 24 hours, the state of the mixture was observed with naked eyes.

O: Variation of compositions such as viscosity increase, gelation and deposition were not acknowledged.

X: Variation of compositions such as viscosity increase, gelation and deposition were acknowledged.

TABLE 3
Evaluation results of physical properties

| | Corrosion | | | |
|---|---|---|---|---|
| | resistance | Adhesion | Storage stability | Cr reactivity |
| Example 6 | Excellent | Excellent | ◯ | ◯ |
| Example 7 | Excellent | Excellent | ◯ | ◯ |
| Example 8 | Excellent | Excellent | ◯ | ◯ |
| Example 9 | Excellent | Excellent | ◯ | ◯ |
| Comparative | Bad | Good | ◯ | X |
| Example 5 | | | | |
| Comparative | Bad | Good | ◯ | X |
| Example 6 | | | | |
| Comparative | Bad | Good | ◯ | X |
| Example 7 | | | | |
| Comparative | Bad | Good | ◯ | X |
| Example 8 | | | | |

According to the embodiments, the metal surface treatment solution is prepared by further comprising the Ti-Alkoxide, the chelating agent, the calcium phosphate-based compound and the colloidal silica, and a surface treated steel sheet is manufactured through surface treatment using the metal surface treatment solution instead of the existing chromate treatment, so that the metal surface treatment solution provides the surface treated steel sheet with improved or the same corrosion resistance and black sulfide stain resistance as those of the conventional treatment while enabling low temperature hardening to thereby improve the quality of the surface treated steel sheet.

1-12. (canceled)

13. A method of manufacturing a surface treated steel sheet, comprising:
applying a metal surface treatment solution comprising:
9˜13% wt % of an epoxy-based silane coupling agent;
5˜9 wt % of an amino-based silane coupling agent;
0.5˜1 wt % of a vanadium compound;
0.5˜1 wt % phosphoric acid;
0.5˜1 wt % of an organic acid;
0.1˜10 wt % of a Ti-Alkoxide;
0.1˜2 wt % of a chelating agent;
0.1˜5 wt % of a calcium phosphate-based compound;
0.2˜10 wt % of a colloidal silica; and
the balance of solvents
to a surface of a steel sheet according to a process selected from the group comprising:
a roll coater process,
a process of squeezing the solution from a roll after spraying the solution, and
a process of dipping the steel sheet in the solution.

14. The method according to claim 13, further comprising:
heating the steel sheet at a temperature of 30˜200° C. after applying the metal surface treatment solution.

15. The method according to claim 13, further comprising:
drying the metal surface treatment solution on the steel sheet to leave behind 0.05˜0.8 g/m² of a dried coating on the surface of the steel sheet after applying the metal surface treatment solution.
